(19) United States
(12) Patent Application Publication
(10) Pub. No.: US 2019/0185257 A1
(43) Pub. Date: Jun. 20, 2019

(54) CUP

(71) Applicant: Ynon Azulay, Kiryat-Ata (IL)

(72) Inventors: Ynon Azulay, Kiryat-Ata (IL); Dalit Aliza Azulay, Kiryat-Ata (IL)

(21) Appl. No.: 16/328,845

(22) PCT Filed: Aug. 16, 2017
(86) PCT No.: PCT/IL2017/050902

§ 371 Date: Feb. 27, 2019

Related U.S. Application Data
(60) Provisional application No. 62/381,591, filed on Aug. 31, 2016.

(51) Int. Cl. B65D 85/816; A47J 43/28; B65D 1/26; B65D 81/38; A47G 21/00; A47G 21/04; A47G 19/22

(52) U.S. Cl. CPC B65D 85/816; A47J 43/28; B65D 1/265; A47G 19/2205; A47G 21/004; A47G 21/04; B65D 81/3869

(57) ABSTRACT

A cup, including a container, including an elongated cell disposed vertically within a rim of the container; and a spoon, disposed within the elongated cell.

### TECHNICAL FIELD

The invention relates to the field of disposable cups. More particularly, the invention relates to a disposable cup including ingredients.

### BACKGROUND

There is a long felt need to provide a disposable cup including most of the ingredients, for making, a cup of coffee, for example, an easy task.

### SUMMARY

A cup, including:
a container, including an elongated cell disposed vertically within a rim of the container; and
a spoon, disposed within the elongated cell.

### BRIEF DESCRIPTION OF THE DRAWINGS

FIG. 1 is a front sectional view of a cup according to one embodiment of the invention.

FIG. 2 is a perspective view front sectional view of the cup of FIG. 1.

### DETAILED DESCRIPTION

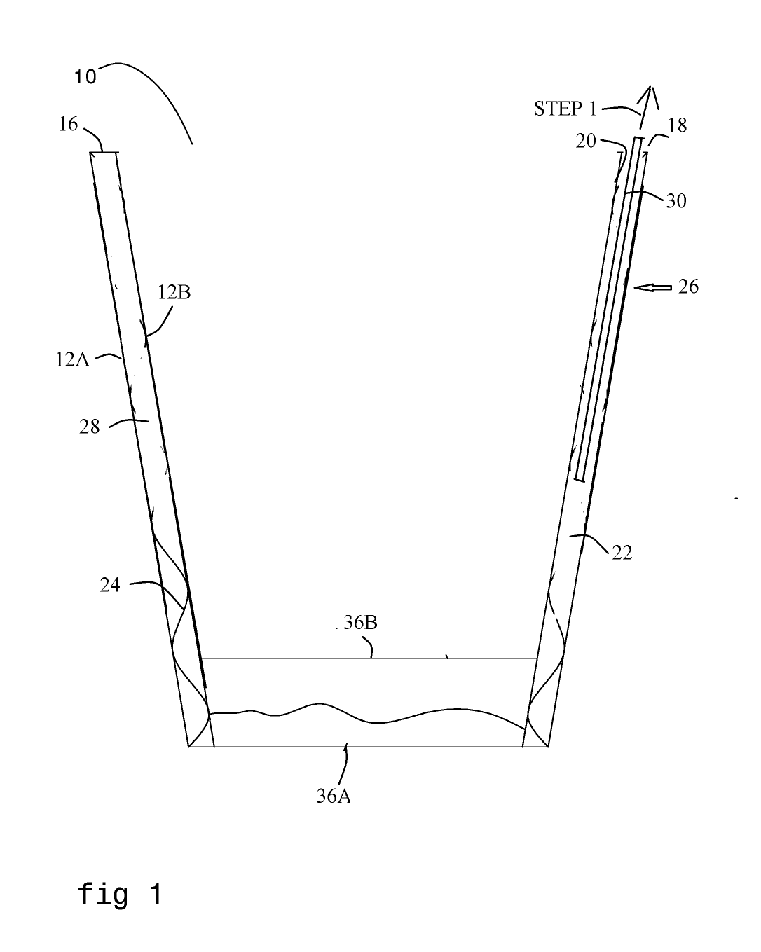

FIG. 1 is a front sectional view of a cup according to one embodiment of the invention.

A cup 10 according to one embodiment of the invention, includes a container 50, including an external peripheral wall 12A and an internal peripheral wall 12B; and a spoon 30, for being stored in an elongated cell 22, disposed between external peripheral wall 12A and internal peripheral wall 12B.

At the first step, the user removes spoon 30, for between external peripheral wall 12A and internal peripheral wall 12B.

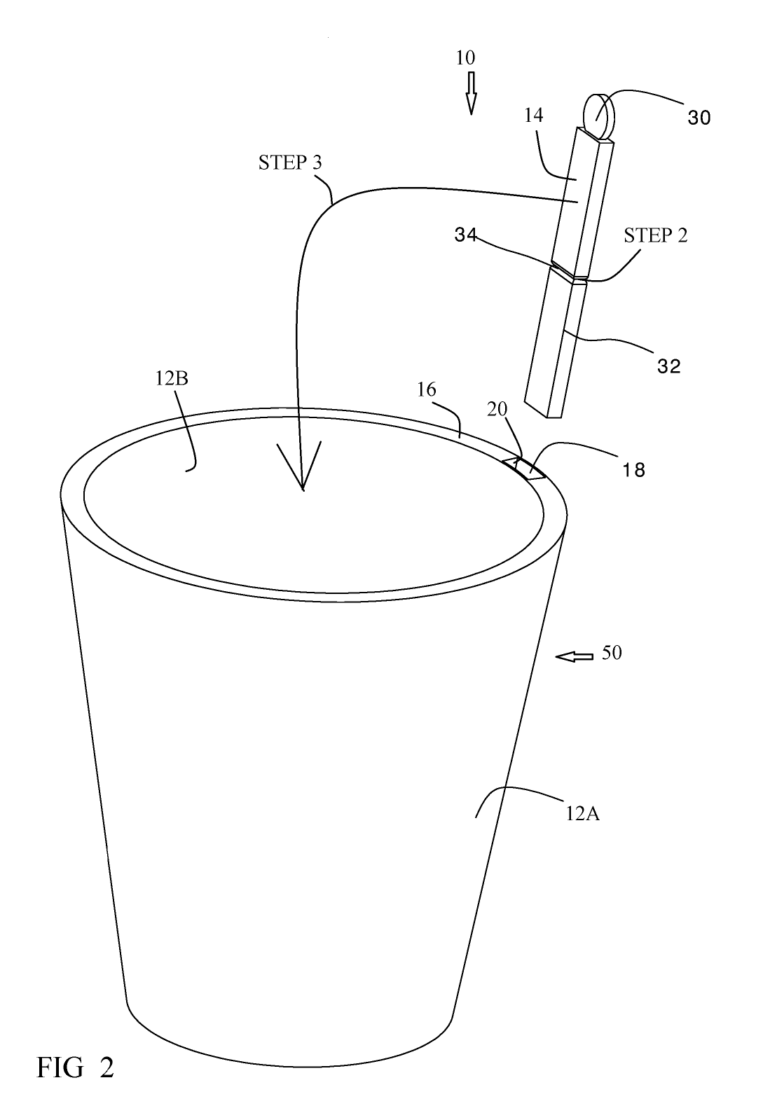

FIG. 2 is a perspective view front sectional view of the cup of FIG. 1.

Spoon 30 is wrapped with sugar 32.

Spoon 30 and sugar 32 include a protrusion 34.

At the second step, the user may break spoon 30 and the wrapping sugar 32, remaining a fraction 14.

At the third step, the user may insert spoon 30, as a whole or fraction 14 into container 50, and the sugar melts in the juice.

External peripheral wall 12A and internal peripheral wall 12B are attached one to the other by a top cover 16, being open by an opening 18, being the opening of cell 22.

Cell 22 further includes vertical walls 20.

Thus, in one aspect, the invention is directed to a cup (10), including
a container (50), including an elongated cell (22) disposed vertically within a rim (26) of the container (50); and
a spoon (30), disposed within the elongated cell (22).

The rim (26) may include:
an external peripheral wall (12A);
an internal peripheral wall (12B); and
a gap (28) between the external (12A) and internal (12B) peripheral walls;
thereby improving heat isolation of the rim (26).

The rim (26) may further include:
a top peripheral cover (16), being open by an opening (18), including a top opening of the elongated cell (22).

The spoon (30) may be surrounded by sugar (32), stuck thereto.

The spoon (30) may include a breaking line (34),
thereby breaking of the spoon (30) selects a fraction of the stuck sugar (32).
Numeral 10 denotes the cup, according to one embodiment of the invention;
numeral 12A denotes the external peripheral wall;
numeral 12B denotes the external peripheral wall;
numeral 14 denotes a fraction of the spoon obtained by breaking the spoon;
numeral 16 denotes a top peripheral cover;
numeral 18 denotes a top opening of the elongated cell;
numeral 20 denotes a vertical cell of the elongated cell;
numeral 22 denotes the vertical cell;
numeral 24 denotes additional connection between the external and internal peripheral walls; the additional connection may constitute an isolating filling;
numeral 26 denotes the container's peripheral rim;
numeral 28 denotes the gap between the internal and external walls;
numeral 30 denotes the spoon;
numeral 32 denotes sugar wrapping the spoon, and being stuck thereto;
numeral 34 denotes a protrusion, functioning as a breaking line;
numeral 36A denotes a bottom floor;
numeral 36B denotes a top floor, being adjacent to the bottom floor;
numeral 38 denotes a gap, disposed between the bottom and top floors;
numeral 50 denotes the container.

The reference numbers should not be interpreted as limiting the claims in any form.

1-7. (canceled)

8. A cup, comprising:
a container including an elongated cell disposed vertically within a rim of the container; and
a spoon disposed within the elongated cell.

9. The cup of claim 8, wherein the rim includes:
an external peripheral wall;
an internal peripheral wall; and
a gap between the external and internal peripheral walls;
thereby improving heat isolation of the rim.

10. The cup of claim 9, wherein the rim includes a top peripheral cover, open by an opening, including a top opening of the elongated cell.

11. The cup of claim 8, wherein the spoon is surrounded by sugar stuck thereto.

12. The cup of claim 11, wherein the spoon includes a breaking line, such that breaking of the spoon selects a fraction of the stuck sugar.

13. The cup of claim 8, wherein the spoon includes a breaking line.

14. The cup of claim 8, further comprising:
a bottom, including:
an bottom floor;
an top floor; and
a gap disposed between the bottom floor and top floor.
